(19) United States
(12) Patent Application Publication
(10) Pub. No.: US 2006/0157988 A1
(43) Pub. Date: Jul. 20, 2006

(54) Engine generator

(76) Inventors: Naoto Mazuka, Shizuoka-ken (JP); Takahide Sugiyama, Shizuoka-ken (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/327,592

(22) Filed: Jan. 6, 2006

(30) Foreign Application Priority Data
Jan. 6, 2005 (JP) 2005-001532

(51) Int. Cl. H02K 7/18; H02K 5/00; F02B 63/04

(52) U.S. Cl. 290/1 A; 123/198 E; 322/1

(57) ABSTRACT

An enclosure of the engine generator can be configured such that a front panel, top panel, intake cover, exhaust cover, rear panel, and bottom panel are attached to a framework made up of a front frame, a rear frame, handles and securing frames. Handholds can be provided in one piece in the undersurface of the bottom panel. The portions in the upper surface of the bottom panel corresponding to the handholds can be used as a pedestal for placing a controller. The pedestal can include two rests, spaced at a constant interval, between which an air guide passage can be formed. The handle and the handholds can be arranged in parallel.

### PRIORITY INFORMATION

This application claims priority under 35 U.S.C. § 119 to Japanese Patent Application No. 2005-001532, filed on Jan. 6, 2005, the entire content of which is expressly incorporated by reference herein.

### BACKGROUND OF THE INVENTION

1. Field of the Invention

The present invention relates to a generator and, more particularly, to a portable generator.

2. Description of the Related Art

Conventional engine generators often have an engine that actuates a generator. The generator, in turn, generates power. Some conventional engine generators have a handle. The handle is configured such that the generator can be gripped with a hand so that the engine generator can be carried. Japanese laid-open application publication, JP-A-Hei 8-223856, is an example of such an engine generator. In this example, the handle has the shape of an inverse “U” and is mounted on the topside of the engine generator. Accordingly, the engine generator can be held and carried by gripping this handle with a hand.

### SUMMARY OF THE INVENTION

An aspect of the present invention is the recognition that it can be difficult for a user to hold the above-described engine generator in a high position by holding only the handle with the user's hand because the engine generator can be particularly heavy. In view of the foregoing problem, it is, therefore, an object of the present invention to provide an engine generator that is capable of being more easily held in a high position.

Accordingly, one aspect of the present invention comprises an engine generator that includes an enclosure and at least one handle mounted on a topside of the enclosure to allow the engine generator to be held with a hand. The enclosure includes a three-dimensional framework and at least a bottom panel that is coupled to the three-dimensional framework. The bottom panel has an undersurface that is provided with a handhold to be held with a hand.

Another aspect of the present invention comprises an engine generator that includes an engine, an electric generator, an enclosure that defines a space in which the engine the electric generator are at least partially positioned, and at least one handle positioned on a topside of the enclosure. The enclosure includes a bottom panel that has an undersurface that includes a handhold.

Another aspect of the present invention comprises an engine generator that includes an engine, an electric generator, and an enclosure configured to enclose the engine and the electric generator. Means are provided on a topside of the enclosure for gripping the generator with a hand. Means are also provided on a bottom side of the enclosure for gripping the generator with a hand.

For purposes of summarizing the invention, certain aspects, advantages and novel features of the invention have been described herein. It is to be understood that not necessarily all such advantages may be achieved in accordance with any particular embodiment of the invention. Thus, the invention may be embodied or carried out in a manner that achieves or optimizes one advantage or group of advantages as taught herein without necessarily achieving other advantages as may be taught or suggested herein.

### BRIEF DESCRIPTION OF THE DRAWINGS

A general structure that implements various features of specific embodiments of the invention will now be described with reference to the drawings. The drawings and the associated descriptions are provided to illustrate embodiments of the invention and not to limit the scope of the invention.

FIG. 1 is a perspective view of an engine according to an embodiment of the present invention.

FIG. 2 is a front elevational view of the engine generator of FIG. 1.

FIG. 3 is a top plan view of the engine generator FIG. 1.

FIG. 4 is a left side elevational view of the engine generator FIG. 1.

FIG. 5 is a right side elevational view of the engine generator FIG. 1.

FIG. 6 is a front view of a front frame of the engine generator FIG. 1.

FIG. 7 is a rear view of the front frame of FIG. 6.

FIG. 8 is a cross-sectional view of a handle that is mounted to a handle mounting portion of the engine generator of FIG. 1.

FIG. 9 is a cross-sectional view taken along line 9-9 of FIG. 8.

FIG. 10 is a bottom view of the handle.

FIG. 11 is a cross-sectional view taken along line 11-11 of FIG. 10.

FIG. 12 is a top plan view of a bottom panel.

FIG. 13 is a rear elevational view of the bottom panel.

FIG. 14 is a side elevational view of the bottom panel.

FIG. 15 is a cross-sectional view taken along line 15-15 of FIG. 12.

FIG. 16 is a cross-sectional view taken along line 16-16 of FIG. 12.

FIG. 17 is a front view of the inside of the engine generator of FIG. 1.

FIG. 18 is a rear view of the inside of the engine generator of FIG. 1.

### DETAILED DESCRIPTION OF THE PREFERRED EMBODIMENTS

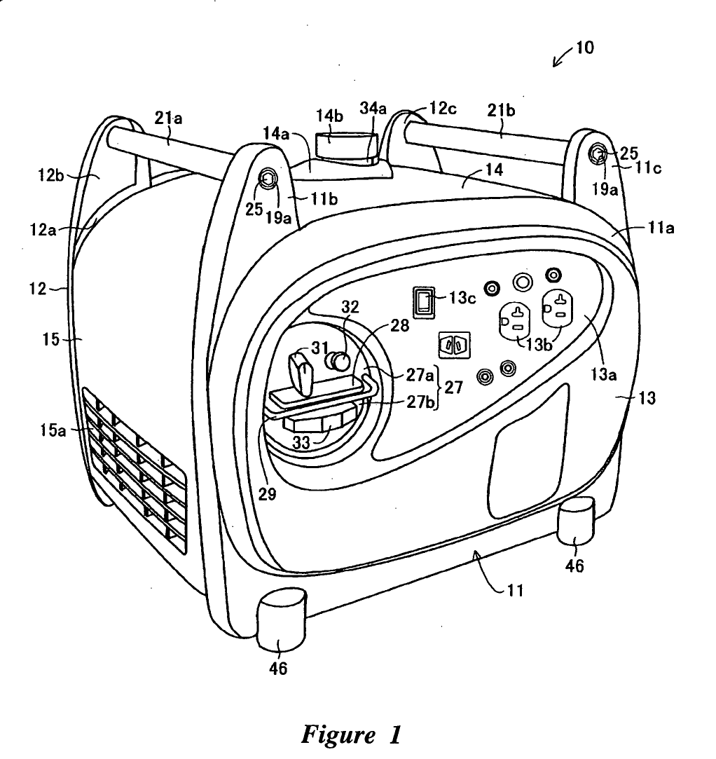

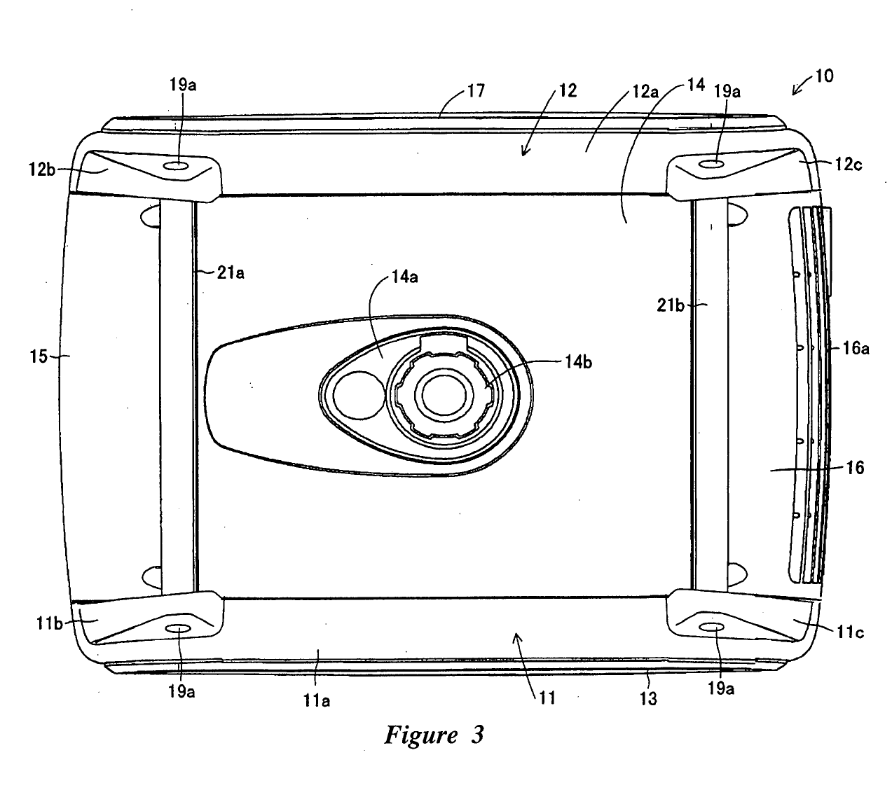

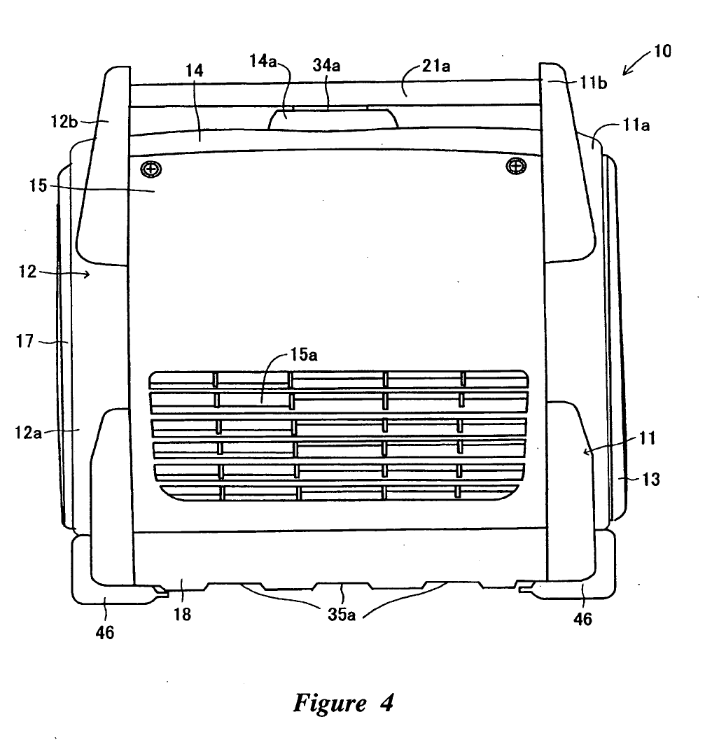

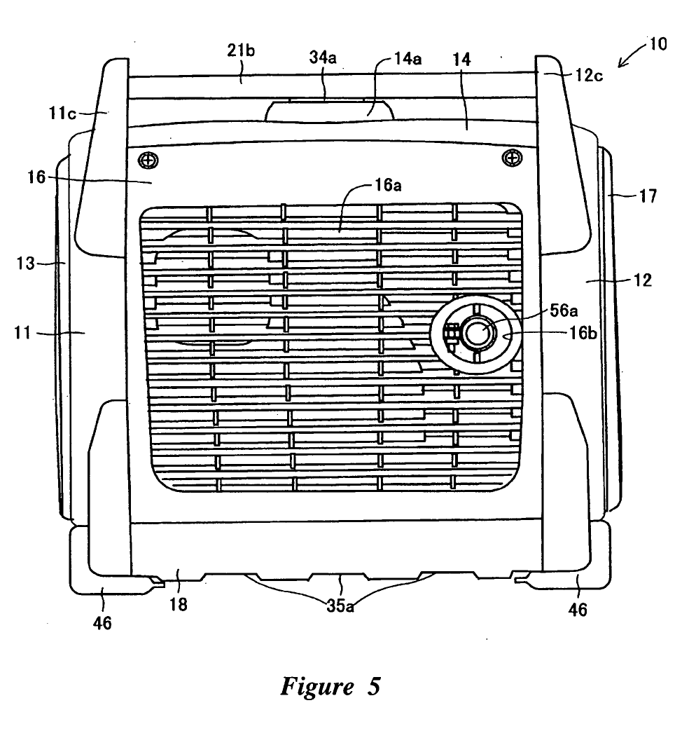

An engine generator 10 in accordance with an embodiment of the present invention will be described below with initial reference to FIGS. 1-5. As illustrated, the outer surface of the engine generator 10 can be formed in a rounded, generally box shape that can comprise a pair of front and rear frames 11, 12 spaced apart from each other in the front-and-back direction; a front panel 13 and a rear panel 17 located within the front frame 11 and the rear frame 12, respectively; and a top panel 14, an intake cover 15, an exhaust cover 16 and a bottom panel 18 located between the front frame 11 and the rear frame 12.

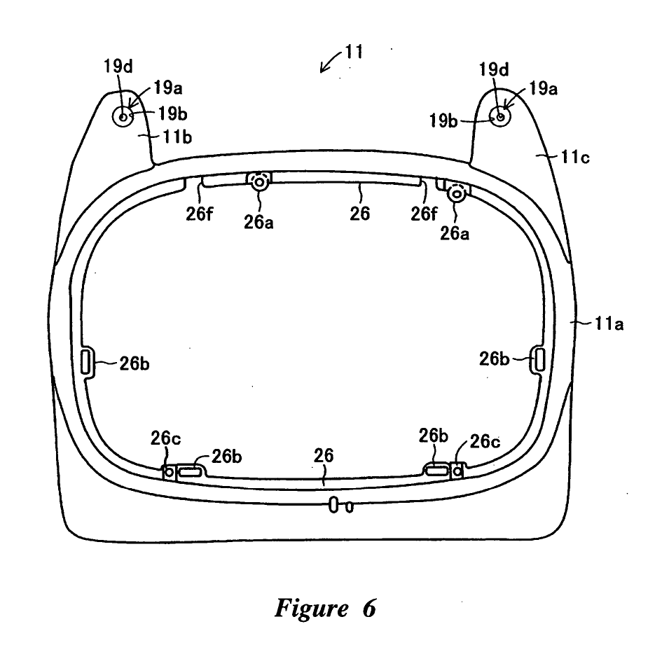

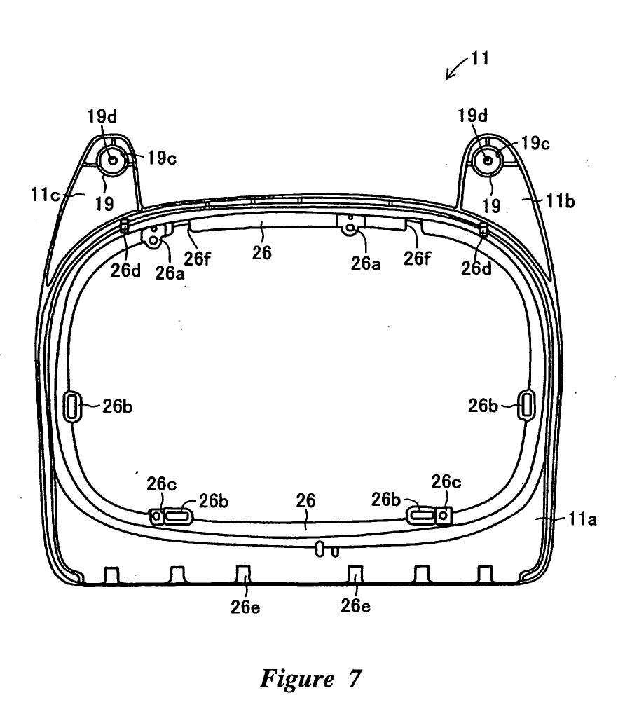

The front frame 11 and the rear frame 12 can be aluminum die castings of the same shape and can be configured as shown in FIGS. 6 and 7 (FIGS. 6 and 7 show the front frame 11). The front frame 11 and the rear frame 12 can include frame bodies 11a, 12a, which can be formed in a generally quadrangle shape with both top sides having a round shape. The top left and right sides of the frame body 11a can be formed with a pair of handle mounting portions 11b, 11c that extend upwards. The top sides of the frame body 12a, in turn, can be formed with a pair of handle mounting portions 12b, 12c that also extend upwards.

As shown in FIG. 1, the upper portions of the handle mounting portions 11b, 11c, 12b, and 12c can be tapered toward the inside of the engine generator 10. The inside faces of the handle mounting portions 11b, 11c, 12b, and 12c in the fore-and-aft direction of the engine generator 10 can each have a recess corresponding to the shape of the outside face, as shown in FIG. 7.

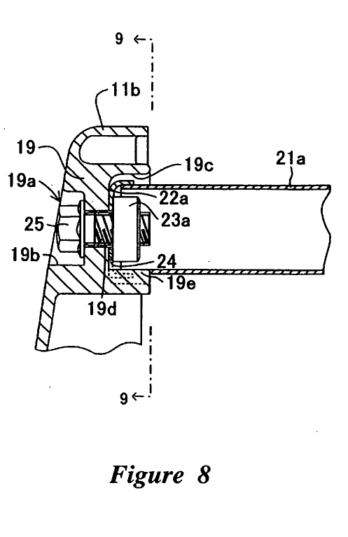

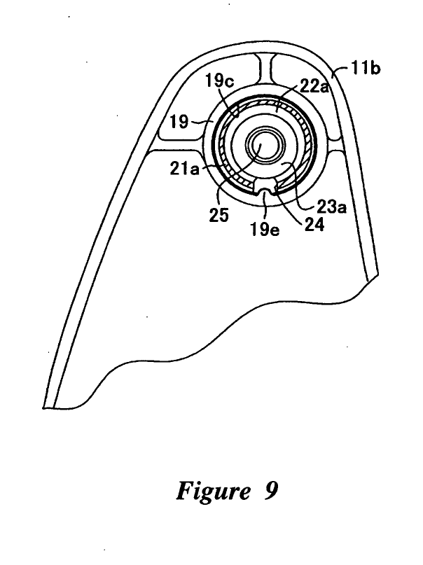

The inside faces of the upper portions of the handle mounting portions 11b, 11c, 12b, and 12c can each formed with a generally cylindrical boss portion 19. The central portion of the boss portion 19 can be formed with an insertion through-hole 19a that can extend in the fore-and-aft direction. As shown in FIG. 8, the insertion hole 19a can include a middle-diameter portion 19b positioned in the outside face of the handle mounting portion, a large-diameter portion 19c positioned in the inside face of the handle mounting portion, and a small-diameter portion 19d formed between the middle-diameter portion 19b and the large-diameter portion 19c. With reference to FIG. 9, a small projection 19e can be formed at the lower edge of the large-diameter portion 19c. Tubular handles 21a, 21b can extend between the opposing handle mounting portions 11b, 12b and 11c, 12c, respectively, and can be attached thereto through the insertion holes 19a.

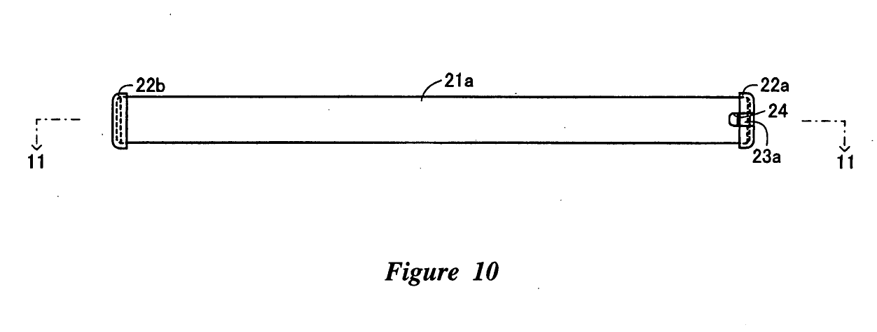

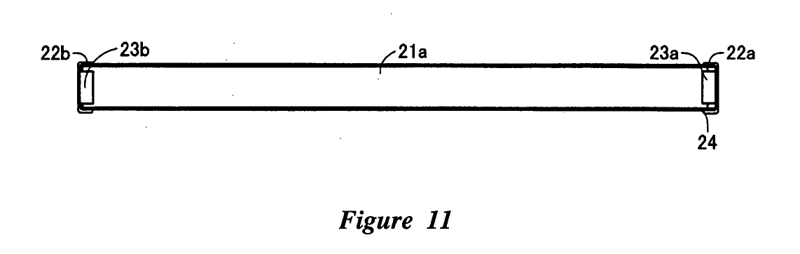

In one embodiment, the handles 21a, 21b can comprise metallic (e.g., iron) pipes. Cap-like plates 22a, 22b can each have a hole formed in their central portions, which are can be mounted to the opposing open ends, respectively, of the respective handles 21a, 21b, as shown in FIGS. 10 and 11 (only the handle 21a is shown). Nuts 23a, 23b can be fixed to the inside faces of the plates 22a, 22b, respectively. A notch 24 can be provided at the ends of the handles 21a, 21b to which the plates 22a are mounted, and at the lower edges of the plates 22a (in the state of FIGS. 8, 9 and 11).

The ends of the handles 21a, 21b to which the plates 22a can be mounted can be positioned in the large-diameter portions 19c of the handle mounting portions 11b, 11c, respectively. The ends of the handles 21a, 21b to which the plates 22b can be mounted can be positioned in the large-diameter portions 19c of the handle mounting portions 12b, 12c, respectively. A bolt 25 can be inserted in each insertion hole 19a and the nut 23a (23b) can be screwed on the bolt 25, so that the ends of the handles 21a, 21b are secured to the corresponding handle mounting portions 11b, 12b, and 11c, 12c.

In the illustrated embodiment, if the small projections 19e of the insertion holes 19a are located in the notches 24 of the handles 21a, 21b, the handles 21a, 21b can be prevented from rotation relative to the handle mounting portions 11b, 12b, and 11c, 12c, respectively. This allows the bolts 25 to be smoothly screwed in the nuts 23a, 23b. The engine generator 10 can be carried by gripping the pair of handles 21a, 21b. In the illustrated embodiment, because the handles 21a, 21b are prevented from rotation due to the engagement of the notch 24 and the small projection 19e, the engine generator 10 can be easily carried.

The inner peripheral edges of the front frame 11 and the rear frame 12 can be formed with rib portions 26 for mounting the front panel 13 and the rear panel 17 along the inner peripheries of the front frame 11 and the rear frame 12. Each rib portion 26 can be formed with plural fitting hole forming portions 26a, 26b, and 26c and mounting projections 26d spaced apart from each other. The axial direction or the direction of the holes of the rib portions 26, all the fitting hole forming portions 26a, 26b, and 26c, and the mounting projections 26d can be the same as that of the boss portions 19. The inside faces of the bottom edges of the front frame 11 and the rear frame 12 can each be formed with six boss portions 26e spaced apart from each other.

In the illustrated embodiment, the front panel 13 can be attached within the front frame 11 along the rib portion 26 and configures a front face of the engine generator 10. In one embodiment, the front panel 13 can be formed of resin material in one piece. The peripheral edge of the front panel 13 can be provided with projections and, for example, sheet-metal clips (not shown). The projections can be inserted in corresponding openings 26f of the rib portion 26, and the sheet-metal clips can be fitted in the fitting hole forming portions 26b, so that the front panel 13 can be mounted to the front frame 11.

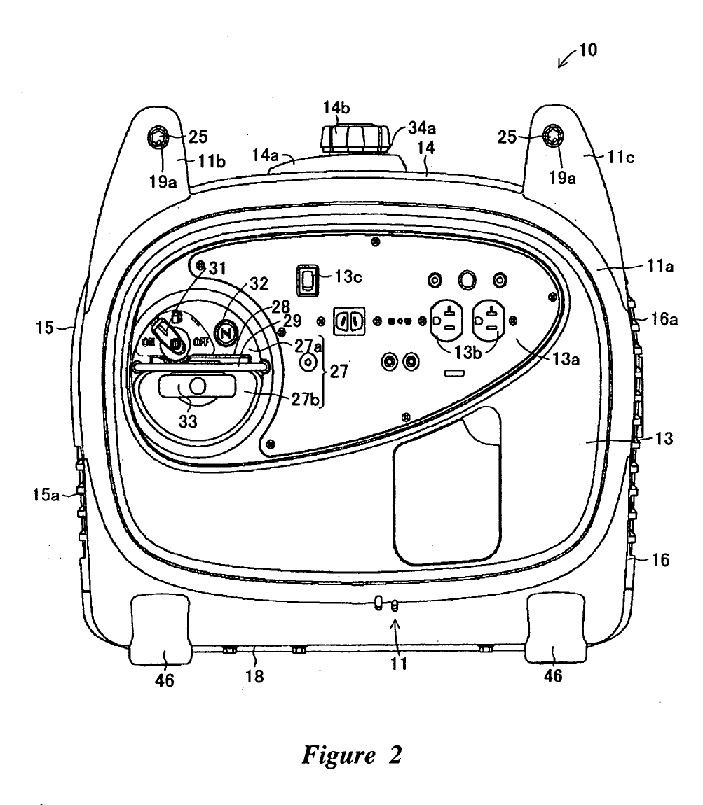

With reference to FIGS. 1-2, the front panel 13 can be formed approximately in the shape of a quadrangle with rounded corners, as seen from the front side. An upper portion of the front panel 13 can be formed with a recess 13a of a generally oval shape having a large vertical width at its left portion (e.g., on the left-hand side of FIGS. 1 and 2) and a small vertical width at its right portion. A circular recess 27 can be formed in the left portion of the recess 13a. There can be provided outlets 13b, various switches 13c, and the like in the portion other than the recess 27 of the recess 13a.

The recess 27 can be separated into an upper portion and a lower portion by a partition 28, which can be horizontally located and can include a plate-like wall member projecting toward the front side. A protective portion 29 of an iron bar can be provided in a manner to enclose the front face and the opposite faces of the partition 28. An upper area 27a configuring the upper portion of the recess 27 can have a smaller (shallower) depth than a lower area 27b configuring the lower portion of the recess 27.

The upper area 27a of a smaller depth can have a cock operating portion 31 and a choke operating portion 32 laterally aligned with each other. The lower area 27b of a larger depth can have a recoil knob 33. The cock operating portion 31, choke operating portion 32 and recoil knob 33 can be disposed in a manner not to project outward from the surface of the peripheral edge of the front panel 13. The partition 28 can be formed with the front panel 13 in one body, and the protective portion 29 can be fixed to the front panel 13 with the ends of the protective portion 29 inserted in the front panel 13.

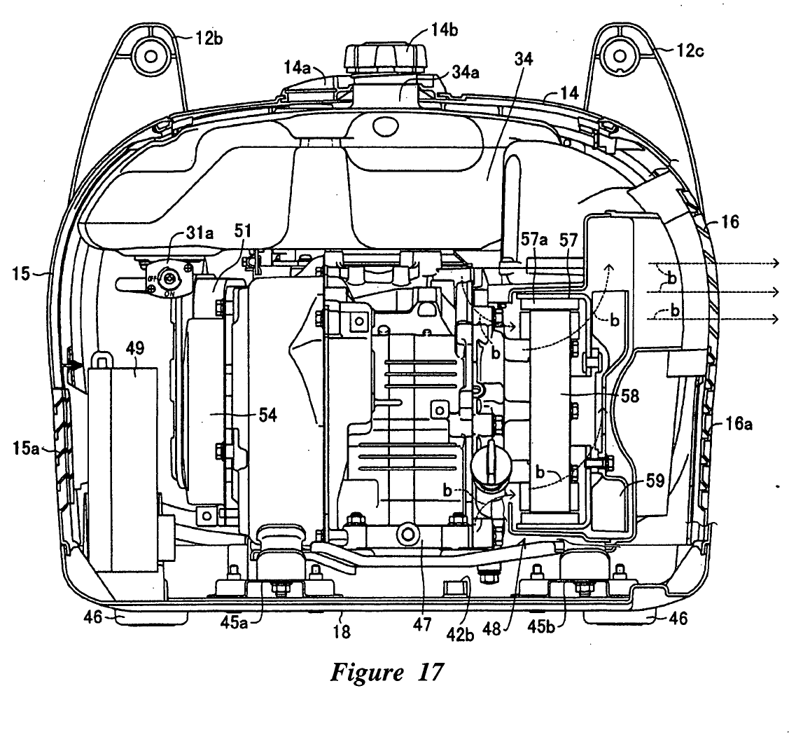

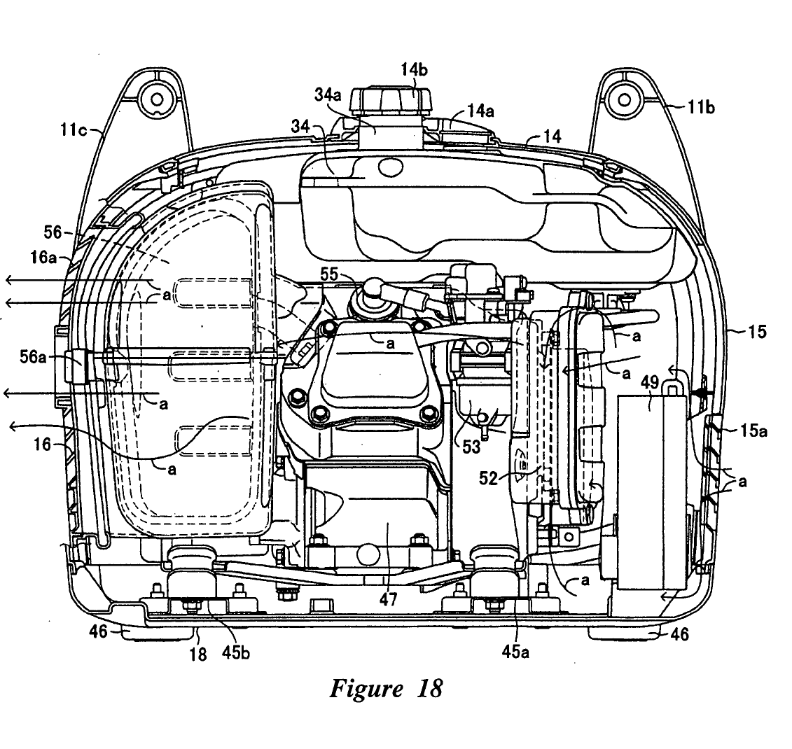

The top panel 14 can be attached between the opposing top edges of the front frame 11 and the rear frame 12 to define a top face of the engine generator 10. The top panel 14 can be formed in the shape of a curved surface and extends laterally with its central portion curved upwards. The generally central portion of the top panel 14 can have a fuel supply portion inserting portion 14a formed to rise for allowing insertion of a fuel supply port 34a of a fuel tank (Refer to FIGS. 17 and 18). A tank cap 14b can be coupled to the fuel supply port 34a through the fuel supply portion inserting portion 14a.

The intake cover 15 and the exhaust cover 16 can be attached between the opposing side edges of the front frame 11 and the rear frame 12 to define side faces of the engine generator 10. A lower portion of the intake cover 15 can be formed with a plurality of lateral intake slits 15a vertically aligned with each other. The exhaust cover 16 at the surface of its large central portion can also be formed with a plurality of lateral exhaust slits 16a vertically aligned with each other. A circular exhaust hole 16b can be formed in a vertically generally central portion on the rear side of the exhaust cover 16.

The top panel 14, the intake cover 15, and the exhaust cover 16 can be mounted to the front frame 11 and the rear frame 12 such that the peripheral edges of those panel and covers are fitted in grooves formed in the front and the rear frames 11, 12. The mounting projections 26d of the front and the rear frames 11, 12 can be used to secure the corresponding portions of the intake cover 15 and the exhaust cover 16.

The rear panel 17 can be attached within the rear frame 12 to define a rear face of the engine generator 10. The overall shape of the rear panel 17 is generally the same as that of the front panel 13. However, in the illustrated embodiment, the rear panel 17 can be formed with no recesses which are equivalent to the recesses 13a and 27 of the front panel 13. As with the front panel 13, both sides of the top edge of the rear panel 17 can be formed with projections to be inserted in the openings 26f of the rib portion 26 of the rear frame 12. Both sides of the inside face of the rear panel 17 can be fitted with sheet-metal clips. Also, there can be screw insertion holes (not shown) in both sides of the bottom peripheral edge of the rear panel 17.

Each fitting hole forming portion 26c can be fitted with a securing member (not shown), to which a nut is fixed. The securing member can have a screw insertion hole formed coaxially with a hole of the nut. The rear panel 17 can be mounted to the rear frame 12 in a way such that: the projections of the rear panel 17 are inserted in the corresponding openings 26f of the rib portion 26 of the rear frame 12; the sheet-metal clips are fitted in the left and right fitting hole forming portions 26b; bolts (not shown) are inserted in the fitting hole forming portions 26c and the screw insertion holes of the securing members; and then the nuts fixed to the securing members are fitted on the ends of the bolts at the inside face of the rear panel 17. The periphery of each screw insertion hole of the outside face of the rear panel 17 can be formed with a recess to prevent the bolt head from projecting outside. The rear panel 17 can be removed by loosening the bolts, in the case of maintenance of the engine generator 10, for instance.

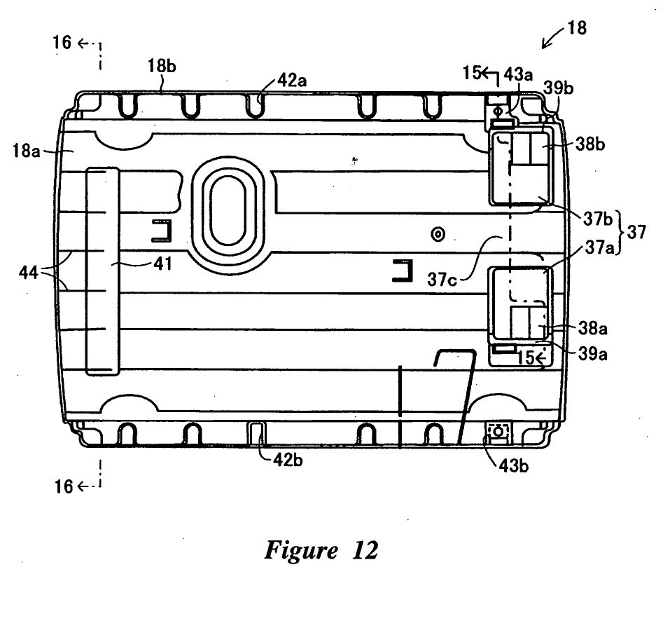

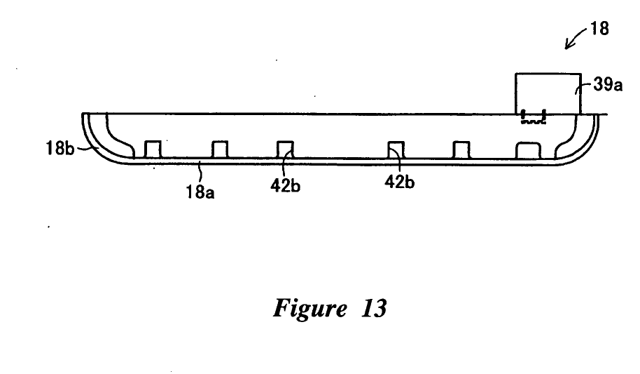

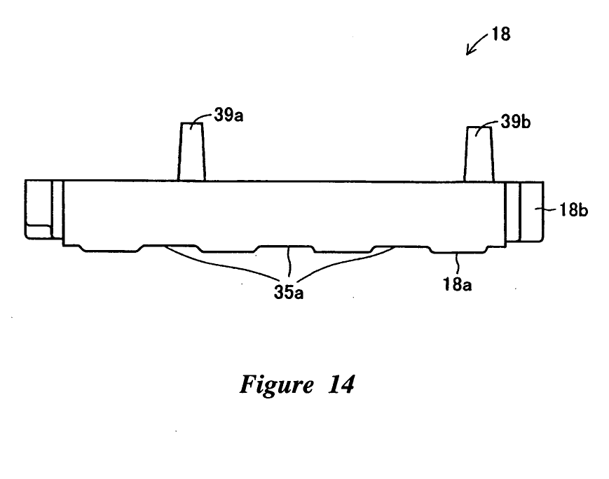

The bottom panel 18 can be fixed between the lower end portions of the front frame 11 and the rear frame 12 to form the bottom of the engine generator 10. This bottom panel 18 can have a configuration as shown in FIGS. 12 to 14, in which its body has: a bottom portion 18a; and a sidewall portion 18b extending from the bottom portion 18a upwardly. The bottom panel 18 can have its undersurface formed with three handholds 35a. The handholds 35a can comprise recesses extending in the right and left direction of the engine generator 10 and can be spaced equally in the fore and aft direction thereof.

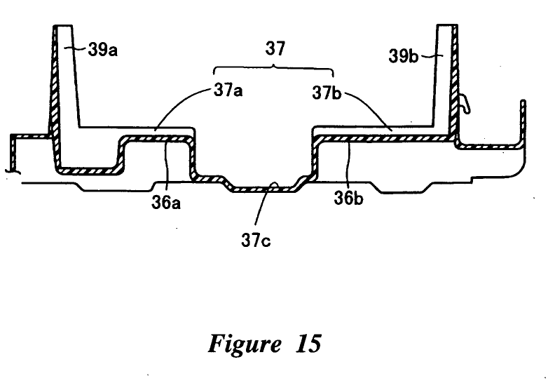

As shown in FIG. 15, in the undersurface of the bottom panel 18 and closer to the intake cover 15, two handholds 36a and 36b can have a depth larger than that of the handhold 35a and can be located in parallel side by side at the vicinity thereof. The handholds 36a and 36b can have: a portion extending toward the central of the bottom panel 18 from the intake cover 15 side; and a portion extending outwardly of the handholds 36a and 36b respectively (i.e., in the fore-and-aft direction of the bottom panel 18, the handhold 36a extends rearward and the handhold 36b forward) from the front end of the former portion. Those larger handholds can be formed in the L-shape, as seen from the bottom side.

In the top surface of the bottom panel 18, there can be formed a pedestal 37 having two rest 37a and 37b that can be formed in the L-shape, at the portion corresponding to the handholds 36a and 36b, respectively. An air guide passage 37c through which air flows can therefore be created between the rests 37a and 37b in the top surface of the bottom panel 18. A support wall 39a can extend upwards such that the rear edge of the rest 37a is connected with the rear end of a concave 38a formed inside of the L-shaped rest 37a, while a support wall 39b can extend upwards such that the front edge of the rest 37b is connected with the front end of a concave 38b formed inside of the L-shaped rest 37b.

The support wall 39a can be formed generally in a U-shape in plan view, with both ends projecting a little forwardly, and the support wall 39b can be formed generally in a U-shape in plan view, with both ends projecting a little rearwardly. A device can be mounted to be stable on the pedestal 37 by putting the device thereon with the opposing sides of the device supported with the support walls 39a and 39b. Additionally, another pedestal 41 can extend in the fore-and-aft direction in the top surface of the bottom panel 18 and closer to the exhaust cover 16 and is also used to place a given device thereon.

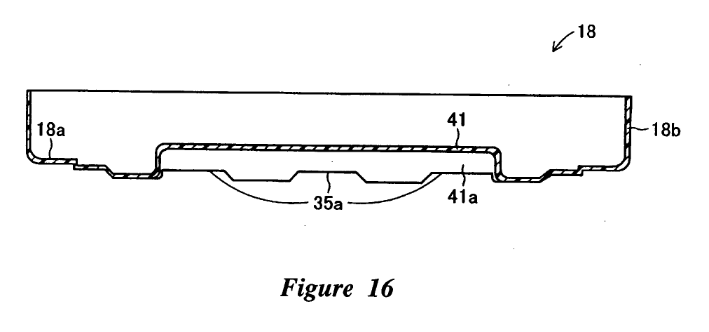

As shown in FIG. 16, in the undersurface of the bottom panel 18 of the illustrated embodiment, there can be a handhold 41a for holding with a hand, at a portion corresponding to the pedestal 41. In the peripheral edge portion of the bottom panel 18, there can be formed: boss portions 42a and securing portions 43a for attaching the bottom panel 18 to the front frame 11 and other members; boss portions 42b and securing portions 43b for attaching the bottom panel 18 to the rear frame 12 and other members; ribs 44 for installing given devices to the bottom panel 18 and used for reinforcement; or the like.

The top panel 14, intake cover 15, exhaust cover 16, rear panel 17 and bottom panel 18 can each integrally formed of resin material. Those panels and the front panel 13 can function as acoustical panels. In the illustrated embodiment, there is interposed a pair of securing frames 45a, 45b made of metal sheets shown in FIGS. 17 and 18 between the front frame 11 and the rear frame 12 to securely connect these frames on the left and right sides. The pair of the securing frames 45a, 45b, the front frame 11, the rear frame 12 and the handles 21a, 21b define a framework according to the present invention. The bottom panel 18 can be mounted between the front frame 11 and the rear frame 12 through the securing frames 45a, 45b.

Preferably, immediately below the upper ends of the handle mounting portions 11b, 11c, 12b, 12c of the right and left portions at the lower ends of the front frame 11 and the rear frame 12 respectively, rubber mounts 46 are correspondingly provided. Each mount 46 can have a bottom portion and a side portion. Each rubber mount 46 can be placed so that the bottom portion is brought to be in contact with the undersurfaces of the front frame 11 and the rear frame 12, and the bottom panel 18, and the side portion extends upwards from a portion in the upper surface of the bottom portion closer to one end thereof and is brought to be in contact with the front surface of the front frame 11 or the surface (outer surface) of the rear frame 12. The rubber mount 46 can be provided with a reinforcing metal (not shown) which extends from the upper face of the bottom portion to the inside of the side portion.

As shown in FIG. 17 and FIG. 18, an engine 47 and a generator 48 can be arranged side by side in the lower portion of the engine generator 10, above which a fuel tank 34 is disposed. The fuel tank 34 can be secured to the front frame 11 and the rear frame 12 through fitting hole forming portions 26a. At the center of the uppermost end of the fuel tank can be provided the fuel supply port 34a described above. At the vicinity of the intake cover 15, in the lower portion of the engine generator 10, a controller 49 as electric accessory can be placed. Specifically, in the illustrate embodiment, the controller 49 sandwiched between the support walls 39a and 39b is fixedly placed on the pedestal 37 through a rubber band (not shown).

An intake fan section 51 for drawing fresh air is attached to the engine 47 at a portion on the controller 49 side. An air cleaner 52 is disposed generally at a central position in the vertical direction within a rear and left space of the engine generator 10. A carburetor 53 can also be disposed adjacent to the air cleaner 52 at a space closer to the central space of the engine generator 10 than the air cleaner 52. The air cleaner 52 can be positioned on the intake side of the engine 47, and introduces and purifies the fresh air drawn by the intake fan section 51 and then feeds it to the carburetor 53.

The carburetor 53 can be connected with one end of the a fuel pipe (not shown) which is connected with the fuel tank 34 via a fuel cock 31a, and one end of a choke cable (not shown) connected to the choke operating portion 32. Thus, when the user operates the cock operating portion 31 to open the fuel cock 31a, fuel in the fuel tank 34 is supplied to the carburetor 53, and when the fuel cock 31a is closed, fuel supply from the fuel tank 34 to the carburetor 53 is stopped.

The fuel supplied from the fuel tank 34 to the carburetor 53 is mixed with the air supplied from the air cleaner 52 to the carburetor 53 into a mixture, which is then supplied to the engine 47 through an intake passage (not shown). Meanwhile, the other end of the choke cable can be connected to the choke operating portion 32. The user can operate the choke operating portion 32 to regulate the richness of the mixture. The recoil knob 33 can be connected to a recoil starter 54 adjoining the engine 47. The recoil starter 54 can be connected to a crankshaft (not shown) of the engine 47, and pulling the recoil knob 33 can cause the recoil starter to rotate the crankshaft to start the engine 47.

The engine 47 can be provided with a spark plug 55, and a muffler 56 can be disposed on the exhaust side of the engine 47 (e.g., a rear portion of the engine generator 10 on the exhaust cover 16 side). The spark plug 55 can ignite the mixture fed from the carburetor 53 to bum the fuel in the engine 47 so that the engine 47 can be operated. Exhaust gas discharged from the engine 47 can be delivered to the muffler 56 and released outside from an exhaust pipe 56a.

The generator 48 can have a rotor shaft (not shown) directly connected to the crankshaft of the engine 47, and can generate power through rotation of the rotor shaft. More specifically, a rotor 57, to which plural magnets 57a can be mounted is disposed on the outer periphery of the rotor shaft, and a stator 58 having a core with a coil wound thereon can be located on the inner peripheral side of the magnets 57a. When the magnets 57a rotate inside the coil with the rotation of the crankshaft, an electromotive force is produced in the coil, so that power is generated. The generator 48 can be provided with an exhaust fan 59, which can be disposed on the upper surface of a platform 41 of the bottom panel 18. In one embodiment, the weight of the engine generator 10 is about 30-40 kg.

In the illustrated configuration, to start the engine generator 10, the user first operates the cock operating portion 31 to open (turn on) a cock and then pulls the choke operating portion 32 adjacent to the cock operating portion 31. In such state, the user pulls the recoil knob 33 to start an engine (not shown). After the engine is warmed up, the user returns the choke operating portion 32 to its original position. Then, power generated by the engine generator 10 can be used in other equipment by plugging a cable in the outlet 13b.

While the engine generator 10 operates, fresh air can be drawn therein via the intake slits 15a of the intake cover 15 by the intake fan section 51, as shown by an arrow “a” of solid line in FIG. 18. The drawn air can pass through the air guide passage 37c that is formed between the top side of the controller 49 and the rests 37a, 37b forming the pedestal 37 under the controller 49 and enters deeply inside of the engine generator 10, where the air is partially drawn into the air cleaner 52, and fed to the carburetor 53 and the engine 47, and finally released, as exhaust gas, from the exhaust pipe 56a of the muffler 56.

The remaining ambient air flows in the vicinity of the engine 47 to cool the engine 47 and the muffler 56 and then exits through the exhaust slits 16a in the exhaust cover 16. The controller 49, the engine 47, and the muffler 57 can be cooled with the cooling wind (shown by the arrows “a”), which flows through the cooling wind passages, to maintain their good operating conditions. Also, while the engine generator 10 is being operated, the air in the engine generator 10 can be drawn in the generator 48, as shown in FIG. 17 by the arrows b of broken lines, as the exhaust fan 59 of the generator 48 is driven. The drawn ambient air cools the generator 48 and then can exit through the exhaust slits 16a in the exhaust cover 16. The generator 48 can be cooled with the cooling wind (shown by the arrows “b”), which flows through the cooling wind passages, to maintain its good operating condition.

While the engine generator 10 is being operated, noise reduction effect of the front panel 13 and other panels may keep the noise from the engine generator 10 low. Before and after use of the engine generator 10, it is easy to hold and carry it by grasping the handles 21a, 21b. When the engine generator 10 is upheld and transferred to a higher position, or plural number of the engine generators 10 are stacked one by one for storing in a storage, for example, the engine generator 10 is upheld by a user with one hand holding one of the handles 21a, 21b and with the other hand putting in one of the handholds 36a, 36b and 41a and grasping the neighborhood thereof.

When the engine generator 10 is upheld by two workers, they can hold the opposing ends of the handhold respectively, which allows them to uphold to a high position or to transfer and stack the engine generators 10 easily. Even if the engine generators 10 are stacked in a plural layers, the engine generators 10 in the lower layers are not damaged due to the weight of those in upper layers since the strength of the framework of the engine generator 10 is sufficiently high.

In this way, the engine generator 10 according to an embodiment of present invention has a pair of the handles 21a, 21b on the both sides of the top surface of the top panel 14. Also, in the undersurface of the bottom panel 18, the handholds 35a of a low concave portion are formed to extend laterally. Further, in the peripheral portion of the bottom panel 18 closer to the intake cover 15, there are formed the handholds 36a, 36b of a high recess, while closer to the exhaust cover 16, there is formed the handhold 41a. Accordingly, when the engine generator 10 is upheld and transferred, the handle 21a is held with one hand and the handhold 41 is held with the other hand, or the handle 21b is held with one hand and the handholds 36a, 36b is held with the other hand.

In this embodiment, the bottom of the engine generator 10 can be more securely held with a hand since the handholds 36a, 36b, and the handhold 41 are formed as deep or high concave portions. It is therefore easy not only to transfer the engine generator 10 to another position, but also to uphold and transfer to a higher position. Since the handhold 35a, the handholds 36a, 36b, and the handhold 41 are formed integrally with the bottom panel 18, man-hour for forming can be reduced.

Both surfaces of the bottom panel 18 can be effectively used, since the portion of the top surface of the bottom panel 18 corresponding to the handholds 36a, 36b in the undersurface of the bottom panel 18 is utilized as the pedestal 37 for placing the controller 49 thereon. Additionally, since the air guide passage 37c is provided between the rests 37a and 37b which form the pedestal 37, the controller can be cooled with a wind passing through the air guide passage, enough to maintain a good operating condition. Since all of the handle 21a, 21b and the handholds 36a, 36b, and the handhold 41a are arranged in parallel with each other, it is easy for one worker to hold one of the handles 21 a, 21b, and one of the handholds 36a, 36b, and the handhold 41a at the same time, resulting in improvement of easiness in carrying the engine generator 10.

Accordingly, in one embodiment, an engine generator comprises an enclosure and at least one handle that is mounted on the topside of the enclosure and allows the engine generator to be held with a hand. The enclosure can include a three-dimensional framework and at least a bottom panel that is attached to the three-dimensional framework. The bottom panel can have an undersurface that is provided with a handhold to be held with a hand.

In the embodiment described above, the handle can be disposed on the topside thereof, and the handhold can be provided in the bottom panel. The engine generator can be therefore carried from one low position to another low position with one or both hands holding the handle. Also, the engine generator can be upheld and transferred from a low position to a high position with one hand holding the handle and the other hand holding the handhold of the bottom panel.

In this way, this engine generator has not only the topside but also the bottom surface and therefore allows to be easily transferred from a low position to a high position. Other than the bottom panel, there may be provided as the members of the enclosure of the engine generator, a front panel, a top panel, an intake and an exhaust cover which form side portions, and a rear panel. Thus, noise can be reduced by such panels which enclose the engine generator.

In one embodiment, the handhold is a concave or convex portion formed integrally with the bottom panel. The bottom panel is preferably formed of resin, which allows the handhold to be formed easily and to be held or gripped securely.

The handhold can be concave and can be formed integrally with the bottom panel; and part of the top surface of the bottom panel, which corresponds to the handhold in the undersurface of the bottom panel, can be a pedestal for mounting an electrical accessory thereon. Thus, for example, when the bottom panel is formed to have a generally fixed thickness and the handhold is defined as a concave portion, a corresponding convex portion appears in the top surface (inside surface) of the bottom panel. This convex portion can be utilized as a pedestal for mounting the electrical accessory thereon. Thus, both surfaces of the bottom panel can be advantageously used, specifically, the convex in the top surface as the pedestal, while the concave in the undersurface as the handhold. The electrical accessory mounted on the pedestal can include a controller, AC/DC converter, switching circuit, inverter and the like. If the handhold is formed as a convex portion, then a concave portion appears in the top surface of the bottom panel. In this case, the pedestal will be provided at a portion other than the concave portion.

The pedestal can be made up of two rests spaced apart from each other at a constant interval, and a space can be defined between the two rests is an air guide passage. In accordance with this feature, it is possible to cool the electrical accessory on the pedestal with an air flowing through the air guide passage. As a result, the electrical accessory on the pedestal are cooled enough to maintain better operating condition. Accordingly, a further advantage is provided by this feature.

In another embodiment, the handle and the handhold can be disposed in parallel with each other. In this embodiment, for example, the handle can be formed as a rod-like member extending in fore-and-aft direction, while the handhold can be formed along the edge extending in the fore-and-aft direction of the bottom panel. This can allow an operator or worker to easily carry or uphold the engine generator since he or she can easily hold the handle and the handhold at the same time.

The engine generator according to the present invention is not intended to limit to the embodiment described herein, and may be modified as required. For instance, in the embodiment as described, the handholds 35a, 36a, 36b, and 41a are formed as recesses or concave portions in the undersurface of the bottom panel 18. However, the handholds according to the present invention are not limited thereto and may be formed as convex potions or projections. In this case, the convex portion s are not limited to those formed in one piece with the bottom panel 18 and may be therefore separate rod-like members to be attached to the bottom panel 18.

The electric accessory to be placed on the pedestal 37 is not limited to the controller 49 and may be therefore an AC/DC converter, switching circuit, inverter, or other devices. Additionally, the construction and materials of the engine generator may be changed as required within the technical scope of the present invention.

In addition, although this invention has been disclosed in the context of certain preferred embodiments and examples, it will be understood by those skilled in the art that the present invention extends beyond the specifically disclosed embodiments to other alternative embodiments and/or uses of the invention and obvious modifications and equivalents thereof. For example, various methods comprising one or more steps and procedures have been described. However, it should be appreciated that in modified embodiments, the order of these steps and procedures can be changed and/or one or more steps and procedures can be combined, eliminated and/or subdivided. In addition, while a number of variations of the invention have been shown and described in detail, other modifications, which are within the scope of this invention, will be readily apparent to those of skill in the art based upon this disclosure. It is also contemplated that various combinations or subcombinations of the specific features and aspects of the embodiments may be made and still fall within the scope of the invention. Accordingly, it should be understood that various features and aspects of the disclosed embodiments can be combine with or substituted for one another in order to form varying modes of the disclosed invention. Thus, it is intended that the scope of the present invention herein disclosed should not be limited by the particular disclosed embodiments described above, but should be determined only by a fair reading of the claims that follow.

What is claimed is:

1. An engine generator comprising an enclosure and at least one handle mounted on a topside of the enclosure to allow the engine generator to be held with a hand, the enclosure including a three-dimensional framework and at least a bottom panel that is coupled to the three-dimensional framework, wherein the bottom panel has an undersurface that is provided with a handhold to be held with a hand.

2. The engine generator according to claim 1, wherein the handhold comprises a recess formed in the bottom panel.

3. The engine generator according to claim 2, wherein the recess is integrally formed in the bottom panel.

4. The engine generator according to claim 1, wherein the handhold comprises a concave or convex recessed portion.

5. The engine generator according to claim 4, wherein the concave or convex portion that is integrally formed with the bottom panel.

6. The engine generator according to claim 1, wherein the handhold comprises a concave portion that is formed integrally with the bottom panel; and part of atop surface of the bottom panel, which corresponds to the handhold in the undersurface of the bottom panel, is a pedestal for mounting an electrical accessory thereon.

7. The engine generator according to claim 6, wherein the pedestal comprises two rests spaced apart from each other at a constant interval, and a space defined between the two rests forms an air guide passage for the generator.

8. The engine generator according to claim 1, wherein the handle and the handhold are disposed in parallel to each other.

9. The engine generator according to claim 1, further comprising an engine and an electric generator at least partially positioned within the enclosure.

10. An engine generator comprising an engine, an electric generator, an enclosure that defines a space in which the engine the electric generator are at least partially positioned, and at least one handle positioned on a topside of the enclosure, the enclosure including a bottom panel that has an undersurface that includes a handhold.

11. The engine generator according to claim 10, wherein the handhold comprises a recess formed in the bottom panel.

12. The engine generator according to claim 11, wherein the recess is integrally formed in the bottom panel.

13. The engine generator according to claim 10, wherein the handhold comprises a concave or convex recessed portion.

14. The engine generator according to claim 13, wherein the concave or convex portion that is integrally formed with the bottom panel.

15. The engine generator according to claim 10, wherein the handhold comprises a concave portion that is formed integrally with the bottom panel; and part of atop surface of the bottom panel, which corresponds to the handhold in the undersurface of the bottom panel, is a pedestal for mounting an electrical accessory thereon.

16. The engine generator according to claim 15, wherein the pedestal comprises two rests spaced apart from each other at a constant interval, and a space defined between the two rests forms an air guide passage.

17. The engine generator according to claim 10, wherein the handle and the handhold are disposed in parallel to each other.

18. The engine generator according to claim 10, wherein the handle comprises a rod.

19. An engine generator comprising an engine, an electric generator, an enclosure configured to enclose the engine and the electric generator, means on a topside of the enclosure for gripping the generator with a hand, and means on a bottom side of the enclosure for gripping the generator with a hand.
